(19) United States
(12) Patent Application Publication
(10) Pub. No.: US 2024/0153393 A1
(43) Pub. Date: May 9, 2024

(54) SYSTEMS AND METHODS FOR DISPLAYING TAXI INFORMATION IN AN AIRCRAFT

(71) Applicant: HONEYWELL INTERNATIONAL INC., Charlotte, NC (US)

(72) Inventors: Zuowei He, Shanghai (CN); Gang He, Morris Plains, NJ (US); Thea Feyereisen, Minneapolis, MN (US)

(73) Assignee: HONEYWELL INTERNATIONAL INC., Charlotte, NC (US)

(21) Appl. No.: 18/053,854

(22) Filed: Nov. 9, 2022

(51) Int. Cl. G08G 5/06; G08G 5/00

(52) U.S. Cl. CPC G08G 5/065; G08G 5/0021

(57) ABSTRACT

Systems and methods are provided for displaying taxi information on an aircraft. The system comprises a display device, a database including taxiing route data that includes a plurality of taxiing routes associated with taxiways and runways at an airport, a communication system configured to receive the taxiing route data from the database, and a processor. The processor is configured to: receive an assigned taxiing route, receive the taxiing route data from the database, analyze the taxiing route data to determine whether modification to the assigned taxiing route is necessary, determine possible taxiing routes from the taxiing routes data based on conditions of the aircraft, predict preferential taxiing routes specific to the aircraft from the possible taxiing routes, generate a display for the display device including the preferential taxiing routes, and receive user input indicating a selected taxiing route from among the preferential taxiing routes.

### TECHNICAL FIELD

The present disclosure generally relates to systems and methods for predicting and displaying taxiing routes in an aircraft at an airport.

### BACKGROUND

During taxi operations, the workload of pilots is, in general, the highest in comparison to any other phase of flight. Complexity for a pilot is further amplified at complicated and unfamiliar airports, and during night and reduced visibility conditions. Cockpit displays with an airport moving map and a graphic depicting taxi clearance and path information are highly useful for reducing the workload.

However, even the most advanced systems intended to reduce the workload of pilots during taxi operations require input by the pilots. For example, the pilots input for clearance originating from an air traffic controller (ATC) is required for path computation and/or selection. This may require typing the clearance designation into a human-machine interface (e.g., a keyboard or touchscreen) ten characters or more, for example, without making any errors. During the workload heavy taxi operations, this task may be challenging for pilots.

Hence, it is desirable to provide systems and methods for reducing the input required by pilots during the taxi operations. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for displaying taxi information on an aircraft. The system comprises a display device, a database including taxiing routes data that includes a plurality of taxiing routes associated with taxiways and runways at an airport, a communication system configured to receive the taxiing route data from the database, and at least one processor in operable communication with the display device and the communication system, the at least one processor configured to execute program instructions, wherein the program instructions are configured to cause the at least one processor to: receive a clearance from an air traffic controller that includes an assigned taxiing route, receive the taxiing route data from the database through the communication system, analyze the taxiing route data to determine whether modification to the assigned taxiing route is necessary due to the assigned taxiing route being incomplete or due to an occurrence of an event that affects the assigned taxiing route, in response to the determination that modification of the assigned taxiing route is necessary, determine possible taxiing routes from the taxiing routes data based on conditions of the aircraft, predict preferential taxiing routes specific to the aircraft from the possible taxiing routes, generate a display for the display device including a graphical or textual depiction of one or more of the preferential taxiing routes on a map of the airport, and receive user input indicating a selected taxiing route from among the one or more of the preferential taxiing routes displayed on the map of the airport.

A method for displaying taxi information on an aircraft. The method comprises receiving, with a processor of the aircraft, a clearance from an air traffic controller that includes an assigned taxiing route for the aircraft, receiving, by the processor, taxiing route data from a database through a communication system of the aircraft, wherein the taxiing route data includes a plurality of taxiing routes associated with taxiways and runways at an airport, analyzing, by the processor, the taxiing route data to determine whether modification to the assigned taxiing route is necessary due to the assigned taxiing route being incomplete or due to an occurrence of an event that affects the assigned taxiing route, in response to the determination that modification of the assigned taxiing route is necessary, determining, by the processor, possible taxiing routes from the taxiing routes data based on conditions of the aircraft, predicting, by the processor, preferential taxiing routes specific to the aircraft from the possible taxiing routes, generating, by the processor, a display for a display device of the aircraft including a graphical or textual depiction of one or more of the preferential taxiing routes on a map of the airport, and receiving, by the processor, user input indicating a selected taxiing route from among the one or more of the preferential taxiing routes displayed on the map of the airport.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a schematic block diagram of an aircraft system including a system for taxiing route prediction in accordance with various embodiments;

FIG. 2 is a data flow diagram illustrating data flow within the system of FIG. 1;

FIG. 3 is a flowchart of a method for taxiing route prediction in an aircraft system in accordance with various embodiments;

FIG. 4 is a first exemplary avionic display that includes visual elements representing taxiing route predictions in accordance with various embodiments;

FIG. 5 is a second exemplary avionic display that includes visual elements representing taxiing route predictions in accordance with various embodiments; and

FIG. 6 is a third exemplary avionic display that includes visual elements representing taxiing route predictions in accordance with various embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. As further appearing herein, the term “pilot” encompasses all users of the below-described aircraft system.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for predicting and displaying taxiing routes for an aircraft at an airport. In particular, the systems are configured to, based on various data, predict possible and/or preferred taxiing routes and display such routes to a pilot as selectable options during taxi operations. These systems and methods are potentially capable of reducing input required by pilots during the taxi operations. For example, in some embodiments a pilot may select a taxiing route displayed by the system corresponding to an air traffic controller's clearance rather than inputting the taxiing route manually.

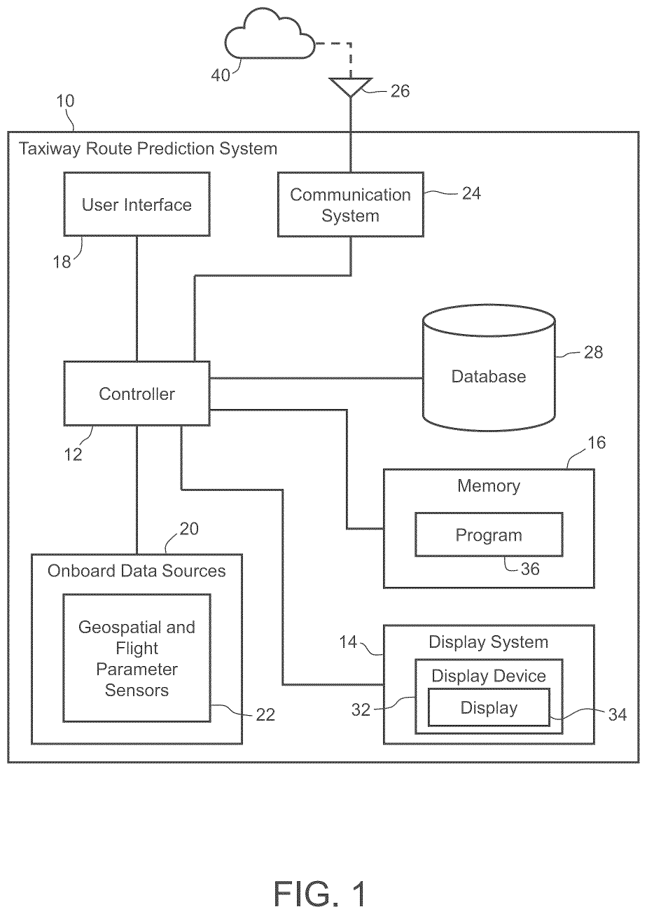

FIG. 1 is a block diagram of a taxiing route prediction system 10, as illustrated in accordance with an exemplary and non-limiting embodiment of the present disclosure. The taxiing route prediction system 10 may be utilized onboard a mobile platform to provide taxiing route predictions, as described herein. In various embodiments, the mobile platform is an aircraft (referred to as the ownship), which carries or is equipped with the taxiing route prediction system 10. As schematically depicted in FIG. 1, the taxiing route prediction system 10 (shortened herein to the system 10) includes the following components or subsystems, each of which may assume the form of a single device or multiple interconnected devices including, but not limited to, a controller 12 operationally coupled to: at least one display device 32, which may optionally be part of a larger on-board display system 14; computer-readable storage media or memory 16; a user interface 18, and ownship data sources 20 including, for example, an array of flight system status and geospatial sensors 22. The system 10 may be separate from or integrated within a flight management system (FMS) and/or a flight control system (FCS). The system 10 may also contain a communication system 24 including an antenna 26, which may wirelessly transmit data to and receive data from various external sources 40 separate from the system 10, such as a cloud-based weather (WX) forecasting service.

Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the aircraft.

The term “controller,” as appearing herein, broadly encompasses those components utilized to carry-out or otherwise support the processing functionalities of the taxiing route prediction system 10. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the ownship. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 1, embodiments of the ownship can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies a wake turbulence algorithm, to thereby perform the various process steps, tasks, calculations, and control/display functions described herein.

The controller 12 may exchange data with one or more external sources 40 to support operation of the system 10 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 can encompass any number and type of storage media suitable for storing computer-readable code or instructions, such as the aforementioned software program 36, as well as other data generally supporting the operation of the system 10. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for predicting taxiing routes for an aircraft and/or airport runway map data may be part of system 10. In certain embodiments, the source is one or more databases 28 employed to receive and store airport runway map data, a plurality of taxiing routes, historical and/or preferential taxiing route data, standardized taxi route, etc., which may be updated on a periodic or iterative basis to ensure data timeliness. In various embodiments, various taxiing route data and/or airport runway map data may be stored in the memory 16 or in the one or more databases 28, and referenced by the program 36. In various embodiments, these databases 28 may be available online and accessible remotely by a suitable wireless communication system, such as the communication system 24.

The sensors 22 supply various types of data and/or measurements to the controller 12. In various embodiments, the sensors 22 supply, without limitation, one or more of: inertial reference system measurements providing a location, Flight Path Angle (FPA) measurements, airspeed data, groundspeed data, vertical speed data, vertical acceleration data, altitude data, attitude data including pitch data and roll measurements, yaw data, data related to ownship weight, time/date information, heading information, data related to atmospheric conditions, flight path data, flight track data, radar altitude data, geometric altitude data, wind speed and direction data. Further, in certain embodiments of the system 10, the controller 12 and the other components of the system 10 may be included within or cooperate with any number and type of systems commonly deployed onboard aircraft including, for example, a flight management system (FMS), an Attitude Heading Reference System (AHRS), an Instrument Landing System (ILS), and/or an Inertial Reference System (IRS).

With continued reference to FIG. 1, the display device 32 can include any number and type of image generating devices on which one or more avionic displays may be produced. In various embodiments, the display device 32 may be affixed to the static structure of the ownship cockpit as, for example, a Head Down Display (HDD) or Head Up Display (HUD) unit. Alternatively, display device 32 may assume the form of a movable display device (e.g., a pilot-worn display device) or a portable display device, such as an Electronic Flight Bag (EFB), a laptop, or a tablet computer carried into the ownship cockpit by a pilot.

At least one avionic display 34 is generated on display device 32 during operation of the system 10. The term “avionic display” as used herein is synonymous with the terms “aircraft-related display” and “cockpit display” and encompasses displays generated in textual, graphical, cartographical, and other formats. The system 10 can generate various types of lateral and vertical avionic displays 34 on which symbology, text annunciations, and other graphics pertaining to flight planning are presented for a pilot to view. The display device 32 is configured to render at least one avionic display 34 showing at least one airport map environment and, optionally, a taxiing route path. The avionic display 34 generated and controlled by the system 10 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

In various embodiments, a human-machine interface, such as a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, icons, and the like, which are used to prompt a user to interact with the human-machine interface to provide user input, and to activate respective functions and provide user feedback, responsive to received user input at the GUI element.

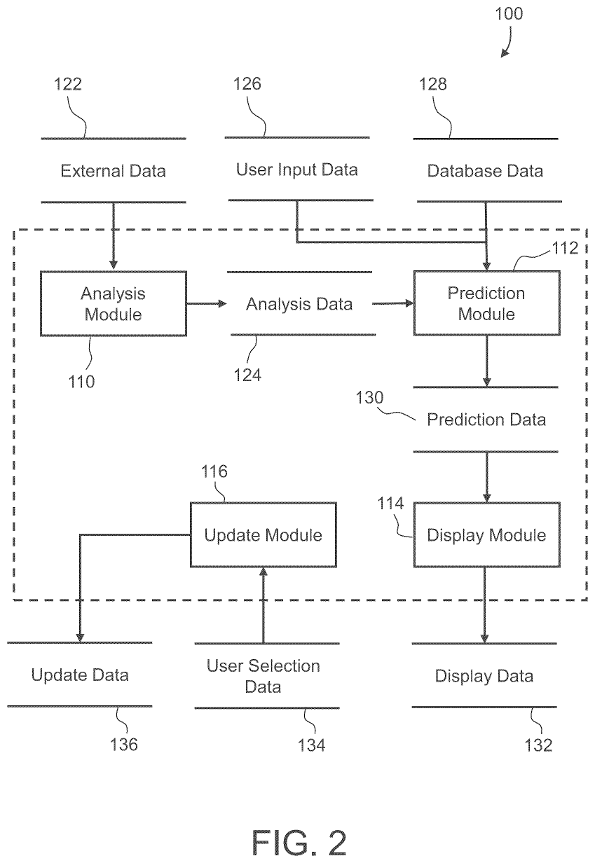

With reference to FIG. 2 and with continued reference to FIG. 1, a dataflow diagram illustrates elements of the system 10 of FIG. 1 in accordance with various embodiments. As can be appreciated, various embodiments of the system 10 according to the present disclosure may include any number of modules embedded within the controller 12 which may be combined and/or further partitioned to similarly implement systems and methods described herein. Furthermore, inputs to the system 10 may be received from other control modules (not shown) associated with the ownship, and/or determined/modeled by other sub-modules (not shown) within the controller 12. In various embodiments, the system 10 includes an analysis module 110, a prediction module 112, a display module 114, and an update module 116.

In various embodiments, the analysis module 110 receives as input external data 122 received from external sources 40 via the communication system 24. Optionally, the analysis module 110 may receive data from the sensors 22 and/or the database 28. The external data 122 includes various data indicating a clearance as provided by an air traffic controller (ATC), airport taxiway map data, and/or current conditions relating to the airport runways/taxiways.

The analysis module 110 analyzes the external data 122, including the clearance provided by the ATC, and determines whether the clearance is complete, especially in regard to taxiing route instructions, and whether modification to the taxiing route instructions is necessary. For example, the clearance may be considered incomplete if the provided taxiing route instructions fail to include all paths (e.g., taxiways) necessary to travel from a starting location (e.g., a terminal) to an ending location (e.g., runway).

In various embodiments, the prediction module 112 receives as input analysis data 124 received generated by the analysis module 110, user input data 126 received from the user interface 18, and/or database data 128 retrieved from the database 28. The analysis data 124 includes various data indicating whether modification to the taxiing route instructions is necessary. The analysis data 124 may also include some or all of the external data 122. The user input data 126 includes various data indicating a user preference to modify the taxiing route instructions provided in the clearance. The database data 128 includes various data indicating airport mapping data (e.g., runways, taxiways, terminals, hangers, etc.), predetermined taxiing routes, and/or other data useful for identifying suitable taxiing routes. In various embodiments, the database data 128 may include a taxiing routes data library that includes data sets each including, for example, start locations, destination locations, cleared taxiways, and hold shorts. The start and destination locations may be areas defined by several vertexes or an area on airport surface. The cleared taxiways may be defined as a string of taxiway IDs. The taxiing routes data library may be generated and updated from one or more sources including, but not limited to, standardized taxiing routes data, statistical taxiing route data of the ownship and/or other aircraft, aircraft trajectory derived from real-time Automatic Dependent Surveillance-Broadcast (ADS-B) traffic data, and/or NOtice To AirMen (NOTAM) closed taxiway/runway data.

Upon a determination that modification to the taxiing route instructions of the clearance is necessary or desired based on the analysis data 124 and/or the user input data 126, the prediction module 112 identifies possible taxiing routes from a plurality of taxiing routes of the database data 128 based on position, heading, ground speed, approach runway, etc. of the ownship, or based on input start and end locations. From these identified possible taxiing routes, the prediction module 112 predicts one or more preferential taxiing routes specific to the ownship. Various systems, methods, algorithms, and the like may be used to predict the preferential taxiing routes. Nonlimiting examples are disclosed in U.S. patent application Ser. No. 16/920,114, the contents of which are incorporated herein in their entirety. In some embodiments, the taxiing routes may be ranked by an algorithm with predefined weight factors and/or input from the pilot of the ownship.

In various embodiments, the display module 114 receives as input prediction data 130 generated by the prediction module 112. The prediction data 130 includes various data indicating the preferential taxiing routes suitable for the ownship.

The display module 114 generates display data 132 configured to be received by the display device 32 to render one or more visual elements on the avionic display 34 that represent at least one preferential taxiing route for selection by the pilot. In various embodiments, the visual elements may include a textual list of paths defining the preferential taxiing route, a selectable icon indicating a identifier for the preferential taxing route, a graphical taxing route overlaid on a map of an airport including, for example, taxiways, runways, and the like, or any other visual element indicating the preferential taxing route.

The update module 116 receives as input user selection data 134 generated by the user interface 18. The user selection data 134 includes various data indicating a selected taxiing route from among the one or more of the preferential taxiing routes displayed on the avionic display 34.

The update module 116 generates update data 136 configured to be received by, for example, the database 28 to update various data therein relating to the database data 128, such as historical aircraft preferences, historical modifications specific to a runway, taxiing route, or destination, or any other type of data that may be used to improve future predictions performed by the prediction module 112.

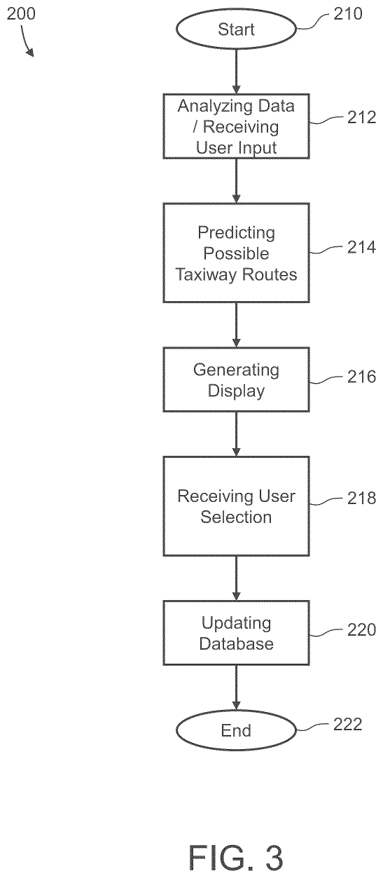

With reference now to FIG. 3 and with continued reference to FIGS. 1-2, a flowchart provides a method 200 for displaying taxiing route prediction information as performed by the system 10, in accordance with exemplary embodiments. As can be appreciated in light of the disclosure, the order of operation within the method 200 is not limited to the sequential execution as illustrated in FIG. 3, but may be performed in one or more varying orders as applicable and in accordance with the present disclosure. In various embodiments, the method 200 can be scheduled to run based on one or more predetermined events (e.g., during taxi operations), and/or can run continuously during operation of the ownship.

In one example, the method 200 may start at 210. The method 200 may include receiving, at 212, data (e.g., via the communication system 24) that includes a clearance provided by an ATC including taxiing route instructions, a plurality of taxiing routes associated with taxiways and runways at an airport, and/or user input. At 214, the method 200 may include determining possible taxiing routes from the plurality of taxiing routes of the data based on, for example, operation of the ownship, and then predicting preferential taxiing routes specific to the ownship from the possible taxiing routes. At 216, the method 200 may include generating a display for a display device including a graphical depiction of one or more of the preferential taxiing routes on a map of the airport. In some embodiments, the graphical depiction includes a selectable visual element. At 218, the method 200 may include receiving a user selection indicating a selected taxiing route from among the one or more preferential taxiing routes displayed on the map of the airport. At 220, the method 200 may include updating a database (e.g., database 28) based on the user selection received. The method 200 may end at 222.

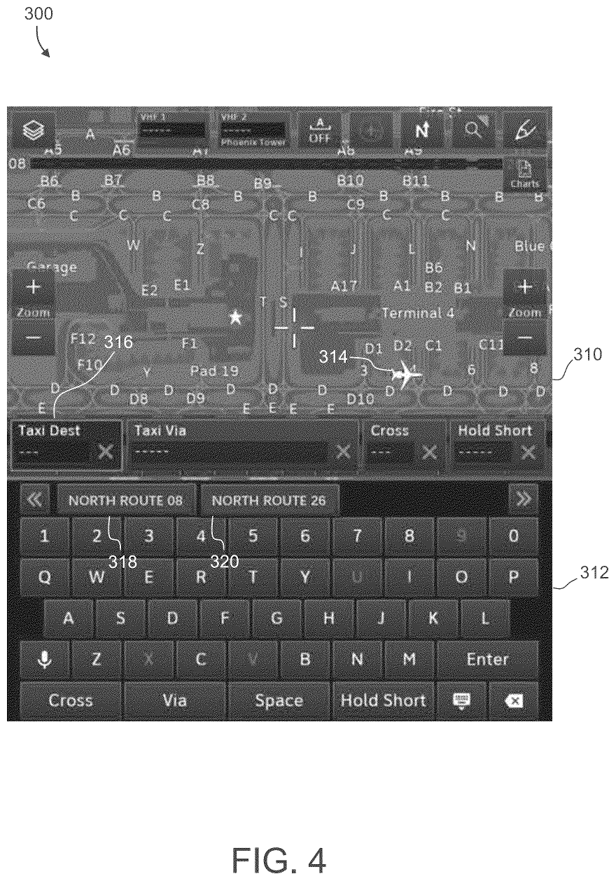

FIGS. 4-6 illustrate various nonlimiting examples of avionic displays 34. It should be noted that these examples are merely for illustrative purposes and the avionic displays 34 of the taxiing route prediction system 10 of FIG. 1 may have other configurations, including various combinations of the visual elements represented in FIGS. 4-6.

FIG. 4 represents a first exemplary avionic display 34 referred to herein as a first display 300 generated on the display device 32 of the display system 14. The first display 300 includes various graphical elements including, but not limited to, a map region 310 representative of an airport including runways, taxiways, terminals, etc., a user interface region 312 including selectable alphanumeric icons (e.g., touchscreen keyboard), an ownship icon 314 indicating a current position of the ownship superimposed on the map region 310, as well as other information and interactive tools. In addition, the first display 300 includes selectable taxiing route icons 318 and 320. The taxiing route icons 318 and 320 represent taxiing routes predicted as being preferential, for example, by the prediction module 112. In this example, the taxiing route icons 318 and 320 are based on standardized taxiing routes associated with a start location of terminal 4 and an end location of runways 8 and 26, respectively. Selection of either of the taxiing route icons 318 and 320 may input a taxiing route with a single interaction with the user interface region 312. For example, selection of the taxiing route icon 318 (i.e., North Route 8) may input a taxiing route that includes taxiing from Taxiway D to Taxiway T, taxiing north on Taxiway T, hold short at Taxiway C for approval to continue, and, upon receiving approval, taxiing from Taxiway C to Runway 8.

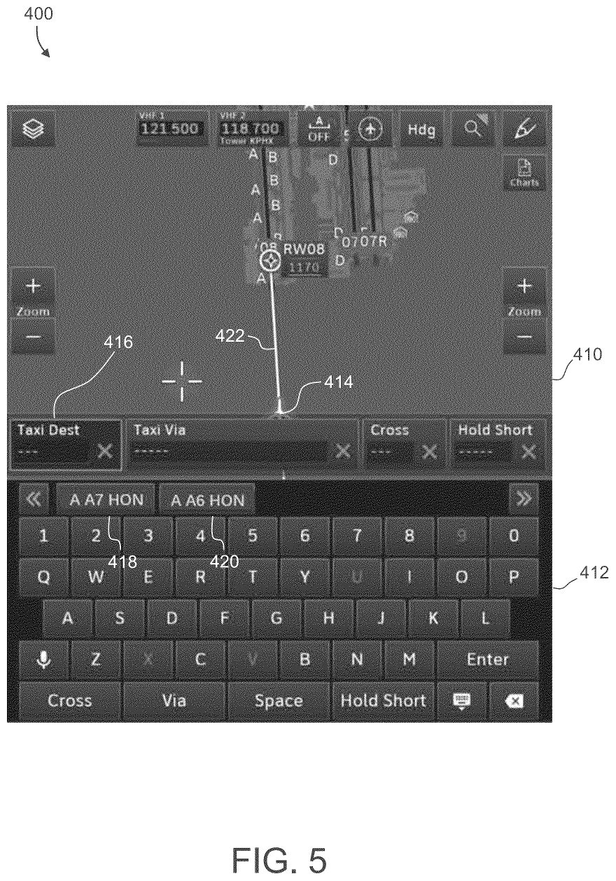

FIG. 5 represents a second exemplary avionic display 34 referred to herein as a second display 400 generated on the display device 32 of the display system 14. The second display 400 includes various graphical elements including, but not limited to, a map region 410 representative of an airport including runways, taxiways, terminals, etc., a user interface region 412 including selectable alphanumeric icons (e.g., touchscreen keyboard), an ownship icon 414 indicating a current position of the ownship superimposed on the map region 410, a flight path 422 of the ownship on approach to the airport, as well as other information and interactive tools. In addition, the second display 400 includes selectable taxiing route icons 418 and 420. The taxiing route icons 418 and 420 represent taxiing routes predicted as being preferential, for example, by the prediction module 112. In this example, the taxiing route icons 418 and 420 are taxiing routes based on statistical taxiing route data of the ownship and/or other aircraft. That is, with the ownship landing on runway 08 of this airport, the prediction module 112 predicts that the taxiing route “A A7 HON” is the most likely taxiing route desired based on historical data.

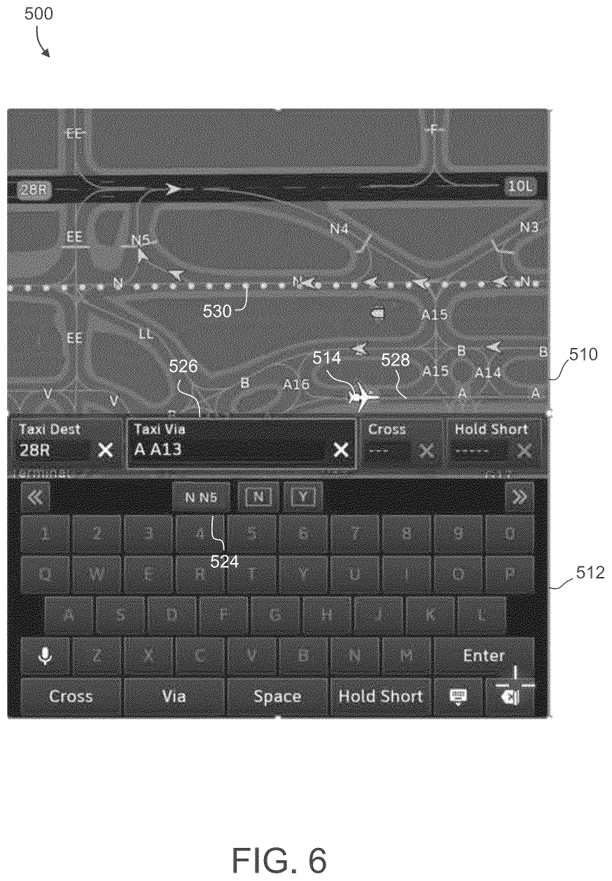

FIG. 6 represents a third exemplary avionic display 34 referred to herein as a third display 500 generated on the display device 32 of the display system 14. The third display 500 includes various graphical elements including, but not limited to, a map region 510 representative of an airport including runways, taxiways, terminals, etc., a user interface region 512 including selectable alphanumeric icons (e.g., touchscreen keyboard), an ownship icon 514 indicating a current position of the ownship superimposed on the map region 510, as well as other information and interactive tools. In addition, the third display 500 includes a selectable taxiing route icon 524. The taxiing route icon 524 represents a taxiing route predicted as being preferential, for example, by the prediction module 112. In this example, the taxiing route icon 524 are based on real-time ADSB traffic data. In this example, traffic flow at the airport indicates that taxiing route “N N5” is the most likely taxiing route based on the traffic data.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for displaying taxi information on an aircraft, the system comprising:
a display device;
a database including taxiing route data, the taxiing route data comprising a plurality of taxiing routes associated with taxiways and runways at an airport;
a communication system configured to receive the taxiing route data from the database; and
at least one processor in operable communication with the display device and the communication system, the at least one processor configured to execute program instructions, wherein the program instructions are configured to cause the at least one processor to:
receive a clearance from an air traffic controller that includes an assigned taxiing route;
receive the taxiing route data from the database through the communication system;
analyze the taxiing route data to determine whether modification to the assigned taxiing route is necessary due to the assigned taxiing route being incomplete or due to an occurrence of an event that affects the assigned taxiing route;
in response to the determination that modification of the assigned taxiing route is necessary, determine possible taxiing routes from the taxiing route data based on conditions of the aircraft;
predict preferential taxiing routes specific to the aircraft from the possible taxiing routes;
generate a display for the display device including a graphical or textual depiction of one or more of the preferential taxiing routes on the display device; and
receive user input indicating a selected taxiing route from among the one or more of the preferential taxiing routes.

2. The system of claim 1, wherein the database includes standardized taxiing routes.

3. The system of claim 1, wherein the database includes historical taxiing routes of the aircraft and other aircraft.

4. The system of claim 1, wherein the database includes Automatic Dependent Surveillance-Broadcast (ADS-B) data.

5. The system of claim 1, wherein the database includes NOtice To AirMen (NOTAM) data.

6. The system of claim 1, wherein the processor is further configured to dynamically predict the preferential taxiing routes from the possible taxiing routes based on past, recent, and present conditions stored in the taxiing route data.

7. The system of claim 1, wherein the processor is further configured to store the selected taxiing route in the database.

8. The system of claim 1, wherein the database includes data sets that each include start locations, destination locations, cleared taxiways, and hold shorts.

9. The system of claim 1, wherein the processor is configured to determine the possible taxiing routes from the taxiing routes of the taxiing routes data based on conditions of the aircraft that include a position of the aircraft, a heading of the aircraft, and a ground speed of the aircraft.

10. The system of claim 1, wherein the taxiing routes in the taxiing routes data are ranked by algorithm with predefined weight factors and the processor is configured to generate the display for the display device to include a visual element configured to be selectable to override the predefined weight factors for pilot customization.

11. A method for displaying taxi information on an aircraft, the method comprising:
receiving, with a processor of the aircraft, a clearance from an air traffic controller that includes an assigned taxiing route for the aircraft;
receiving, by the processor, taxiing route data from a database through a communication system of the aircraft, wherein the taxiing route data includes a plurality of taxiing routes associated with taxiways and runways at an airport;
analyzing, by the processor, the taxiing route data to determine whether modification to the assigned taxiing route is necessary due to the assigned taxiing route being incomplete or due to an occurrence of an event that affects the assigned taxiing route;
in response to the determination that modification of the assigned taxiing route is necessary, determining, by the processor, possible taxiing routes from the taxiing routes data based on conditions of the aircraft;
predicting, by the processor, preferential taxiing routes specific to the aircraft from the possible taxiing routes;
generating, by the processor, a display for a display device of the aircraft including a graphical or textual depiction of one or more of the preferential taxiing routes on a map of the airport; and
receiving, by the processor, user input indicating a selected taxiing route from among the one or more of the preferential taxiing routes displayed on the map of the airport.

12. The method of claim 11, wherein the database includes standardized taxiing routes.

13. The method of claim 11, wherein the database includes historical taxiing routes of the aircraft and other aircraft.

14. The method of claim 11, wherein the database includes Automatic Dependent Surveillance-Broadcast (ADS-B) data.

15. The method of claim 11, wherein the database includes NOtice To AirMen (NOTAM) data.

16. The method of claim 11, further comprising, by the processor, dynamically predicting the preferential taxiing routes from the possible taxiing routes based on past, recent, and present conditions stored in the taxiing route data.

17. The method of claim 11, further comprising, by the processor, storing the selected taxiing route in the database.

18. The method of claim 11, wherein the database includes data sets that each include start locations, destination locations, cleared taxiways, and hold shorts.

19. The method of claim 11, further comprising, by the processor, determining the possible taxiing routes from the taxiing routes of the taxiing routes data based on conditions of the aircraft that include a position of the aircraft, a heading of the aircraft, and a ground speed of the aircraft.

20. The method of claim 11, wherein the taxiing routes in the taxiing routes data are ranked by algorithm with predefined weight factors and the method comprises, by the processor, generating the display for the display device to include a visual element configured to be selectable to override the predefined weight factors for pilot customization.
